(19) United States
(12) Patent Application Publication
(10) Pub. No.: US 2015/0154210 A1
(43) Pub. Date: Jun. 4, 2015

(54) COMPUTER ECOSYSTEM WITH AUTOMATICALLY CURATED CONTENT

(71) Applicant: SONY CORPORATION, Tokyo (JP)

(72) Inventor: JASON CLEMENT, San Diego, CA (US)

(73) Assignee: SONY CORPORATION, Tokyo (JP)

(21) Appl. No.: 14/095,410

(22) Filed: Dec. 3, 2013

(51) Int. Cl. G06F 17/30

(52) U.S. Cl. CPC G06F 17/30091

(57) ABSTRACT

Electronic images are programmatically analyzed and metadata associated with the images automatically populated with contextually relevant tags and markers for later referencing the images for curated entertainment. Algorithms for facial recognition, spatial recognition, object recognition, brand recognition, geo-specific data and time specific events can be programmatically applied to this end. Additional cross-referencing is afforded to prior searches, and existing databases and data sets are compared to provide more relevant context and update the metadata.

### FIELD OF THE INVENTION

The present application relates generally to computer ecosystems and more particularly to automatically curated content.

### BACKGROUND OF THE INVENTION

A computer ecosystem, or digital ecosystem, is an adaptive and distributed socio-technical system that is characterized by its sustainability, self-organization, and scalability. Inspired by environmental ecosystems, which consist of biotic and abiotic components that interact through nutrient cycles and energy flows, complete computer ecosystems consist of hardware, software, and services that in some cases may be provided by one company, such as Sony. The goal of each computer ecosystem is to provide consumers with everything that may be desired, at least in part services and/or software that may be exchanged via the Internet. Moreover, interconnectedness and sharing among elements of an ecosystem, such as applications within a computing cloud, provides consumers with increased capability to organize and access data and presents itself as the future characteristic of efficient integrative ecosystems.

Two general types of computer ecosystems exist: vertical and horizontal computer ecosystems. In the vertical approach, virtually all aspects of the ecosystem are owned and controlled by one company, and are specifically designed to seamlessly interact with one another. Horizontal ecosystems, one the other hand, integrate aspects such as hardware and software that are created by other entities into one unified ecosystem. The horizontal approach allows for greater variety of input from consumers and manufactures, increasing the capacity for novel innovations and adaptations to changing demands.

Present principles are directed to specific aspects of computer ecosystems, specifically, searching electronic images for specific people or places. This entails visually inspecting each photo and annotating metadata with the relevant content details, a tedious manual process. Some programs allow image searches on specific keywords but only on images that have been processed by specific search engines. In these models, the relevant metadata locus is external to the photo and only accessible when within the specific ecosystem of the program.

### SUMMARY OF THE INVENTION

Present principles facilitate programmatically analyzing electronic images and automatically populating metadata associated with the images with contextually relevant tags and markers for later referencing the photos for curated entertainment. The system programmatically applies algorithms for facial recognition, spatial recognition, object recognition, brand recognition, geo-specific data and time specific events. Additional cross-referencing is afforded to prior searches, and existing databases and data sets are compared to provide more relevant context.

A device includes at least one computer readable storage medium bearing instructions executable by a processor and at least one processor configured for accessing the computer readable storage medium to execute the instructions to configure the processor for recognizing at least one feature in an electronic image. Based on recognizing the at least one feature, the processor automatically associates the image with an original metadata indicating the at least one feature. Also, the processor accessing the instructions is configured for comparing the original metadata with information in a data structure of prior terms, and based on the comparing the original metadata with information in the data structure of prior terms, replacing the original metadata with modified metadata, or adding to the original metadata.

The prior terms may include prior user-input search terms obtained from search terms entered by the public at large or obtained solely from search terms entered into the device. In examples, the processor when executing the instructions is configured for replacing the original metadata with one or more synonyms of the original metadata that appear in the data structure of prior terms. In other examples, the processor when executing the instructions is configured for adding to the original metadata one or more added metadata associated with the original metadata that appear in the data structure of prior terms. The processor when executing the instructions may be configured for replacing the original metadata with modified metadata, or adding modified metadata to the original metadata, only if the modified metadata appears in the data structure of prior terms to satisfy a threshold. The threshold can be adaptive and may be established at least in part by a number of times the original metadata appears in the data structure of prior terms.

In another aspect, a method includes analyzing a digital image, and based on analyzing the digital image, automatically associating metadata describing the image with the image. The method includes modifying the metadata based at least in part on information in a database.

In another aspect, a system includes at least one computer readable storage medium bearing instructions executable by a processor which is configured for accessing the computer readable storage medium to execute the instructions to configure the processor for programmatically analyzing digital images. Based at least in part on programmatically analyzing the images, the instructions configure the processor for automatically populating metadata associated with the images with contextually relevant tags and markers for later referencing the images for curated entertainment, and cross-referencing prior searches and/or existing databases and/or data sets to modify at least one of the tags to provide more relevant context and update the metadata.

The details of the present invention, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 is a flowchart of example overall logic; and

FIG. 3 is a schematic representation of example metadata.

### DETAILED DESCRIPTION OF THE PREFERRED EMBODIMENT

This disclosure relates generally to computer ecosystems including aspects of consumer electronics (CE) device based user information in computer ecosystems. A system herein may include server and client components, connected over a network such that data may be exchanged between the client and server components. The client components may include one or more computing devices including portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, operating systems from Microsoft, or a Unix operating system, or operating systems produced by Apple Computer or Google. These operating environments may be used to execute one or more browsing programs, such as a browser made by Microsoft or Google or Mozilla or other browser program that can access web applications hosted by the Internet servers discussed below.

Servers may include one or more processors executing instructions that configure the servers to receive and transmit data over a network such as the Internet. Or, a client and server can be connected over a local intranet or a virtual private network.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

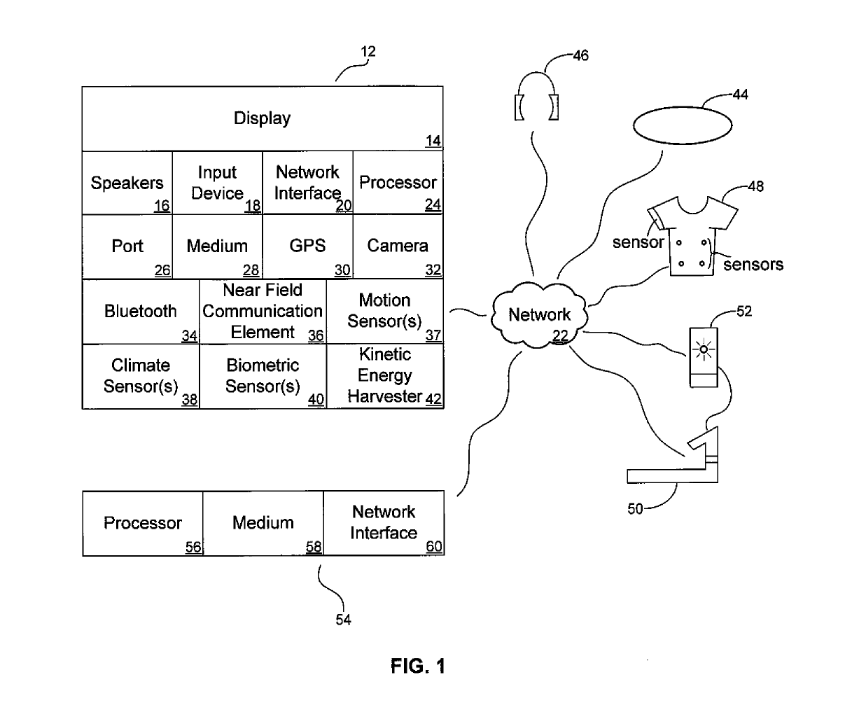

Now specifically referring to FIG. 1, an example system 10 is shown, which may include one or more of the example devices mentioned above and described further below in accordance with present principles. The first of the example devices included in the system 10 is an example consumer electronics (CE) device 12 that may be waterproof (e.g., for use while swimming). The CE device 12 may be, e.g., a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc., and even e.g. a computerized Internet-enabled television (TV). Regardless, it is to be understood that the CE device 12 is configured to undertake present principles (e.g. communicate with other CE devices to undertake present principles, execute the logic described herein, and perform any other functions and/or operations described herein).

Accordingly, to undertake such principles the CE device 12 can be established by some or all of the components shown in FIG. 1. For example, the CE device 12 can include one or more touch-enabled displays 14, one or more speakers 16 for outputting audio in accordance with present principles, and at least one additional input device 18 such as e.g. an audio receiver/microphone for e.g. entering audible commands to the CE device 12 to control the CE device 12. The example CE device 12 may also include one or more network interfaces 20 for communication over at least one network 22 such as the Internet, an WAN, an LAN, etc. under control of one or more processors 24. It is to be understood that the processor 24 controls the CE device 12 to undertake present principles, including the other elements of the CE device 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, WiFi transceiver, etc.

In addition to the foregoing, the CE device 12 may also include one or more input ports 26 such as, e.g., a USB port to physically connect (e.g. using a wired connection) to another CE device and/or a headphone port to connect headphones to the CE device 12 for presentation of audio from the CE device 12 to a user through the headphones. The CE device 12 may further include one or more tangible computer readable storage medium 28 such as disk-based or solid state storage, it being understood that the computer readable storage medium 28 may not be a carrier wave. Also in some embodiments, the CE device 12 can include a position or location receiver such as but not limited to a GPS receiver and/or altimeter 30 that is configured to e.g. receive geographic position information from at least one satellite and provide the information to the processor 24 and/or determine an altitude at which the CE device 12 is disposed in conjunction with the processor 24. However, it is to be understood that that another suitable position receiver other than a GPS receiver and/or altimeter may be used in accordance with present principles to e.g. determine the location of the CE device 12 in e.g. all three dimensions.

Continuing the description of the CE device 12, in some embodiments the CE device 12 may include one or more cameras 32 that may be, e.g., a thermal imaging camera, a digital camera such as a webcam, and/or a camera integrated into the CE device 12 and controllable by the processor 24 to gather pictures/images and/or video in accordance with present principles. Also included on the CE device 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the CE device 12 may include one or more motion sensors 37 (e.g., an accelerometer, gyroscope, cyclometer, magnetic sensor, infrared (IR) motion sensors such as passive IR sensors, an optical sensor, a speed and/or cadence sensor, a gesture sensor (e.g. for sensing gesture command), etc.) providing input to the processor 24. The CE device 12 may include still other sensors such as e.g. one or more climate sensors 38 (e.g. barometers, humidity sensors, wind sensors, light sensors, temperature sensors, etc.) and/or one or more biometric sensors 40 providing input to the processor 24. In addition to the foregoing, it is noted that in some embodiments the CE device 12 may also include a kinetic energy harvester 42 to e.g. charge a battery (not shown) powering the CE device 12.

Still referring to FIG. 1, in addition to the CE device 12, the system 10 may include one or more other CE device types such as, but not limited to, a computerized Internet-enabled bracelet 44, computerized Internet-enabled headphones and/or ear buds 46, computerized Internet-enabled clothing 48, a computerized Internet-enabled exercise machine 50 (e.g. a treadmill, exercise bike, elliptical machine, etc.), etc. Also shown is a computerized Internet-enabled entry kiosk 52 permitting authorized entry to a space. It is to be understood that other CE devices included in the system 10 including those described in this paragraph may respectively include some or all of the various components described above in reference to the CE device 12 such but not limited to e.g. the biometric sensors and motion sensors described above, as well as the position receivers, cameras, input devices, and speakers also described above.

Now in reference to the afore-mentioned at least one server 54, it includes at least one processor 56, at least one tangible computer readable storage medium 58 that may not be a carrier wave such as disk-based or solid state storage, and at least one network interface 60 that, under control of the processor 56, allows for communication with the other CE devices of FIG. 1 over the network 22, and indeed may facilitate communication between servers and client devices in accordance with present principles. Note that the network interface 60 may be, e.g., a wired or wireless modem or router, WiFi transceiver, or other appropriate interface such as, e.g., a wireless telephony transceiver.

Accordingly, in some embodiments the server 54 may be an Internet server, may include and perform “cloud” functions such that the CE devices of the system 10 may access a “cloud” environment via the server 54 in example embodiments.

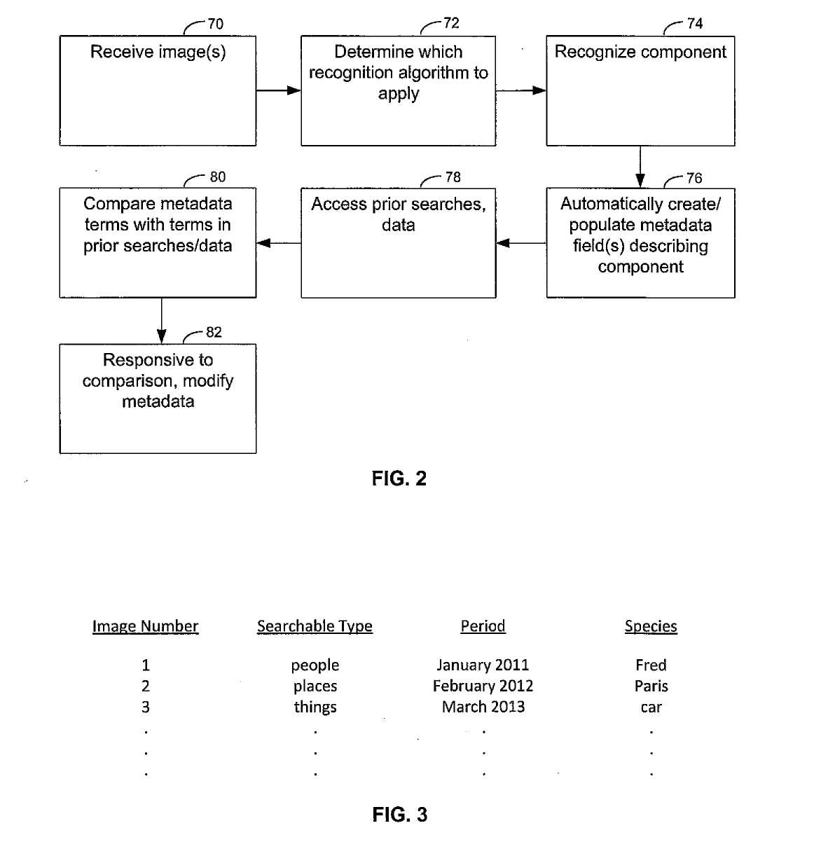

Now referring to FIG. 2, which shows logic that may be implemented by any of the processors above alone or in combination, one or more electronic images such as still digital images or digital video image frames are received at block 70. The images are generated by still or video digital cameras and provided to one or more processors for storage on one or more storage media, and may be sent over a wired or wireless network through appropriate transmitters or interfaces to other processors for execution of the logic described below. Note that the while the example below focuses on digital images, digital audio similarly may be recognized by audio recognition engines and tagged with metadata descriptors.

Proceeding to block 72, in some examples the processor may decide which one of plural software-implemented image recognition algorithms to apply. For example, the processor may have access to a facial recognition algorithm, a spatial recognition algorithm, an object recognition algorithm, a brand recognition algorithm, a geo-specific data recognition algorithm, and an algorithm for recognizing time specific events. The user may establish which algorithm to select, or the processor may undertake the selection automatically as described below. In some cases a single algorithm may provide the capability to recognize two or more of the recognition types above.

An algorithm for deciding which one of a set of specific recognition algorithms to apply is now described. The processor may determine that an image includes human faces by virtue of detecting pixel patterns with enclosed generally ovular borders. Having determined on this basis that a face exists in the image, a face recognition algorithm may be employed to compare features of the face as reflected in pixel patterns within the face image to a database of known faces to identify, at block 74, the person being imaged.

Or, the processor may determine that it should invoke a spatial recognition algorithm by determining that a continuous area of blue pixels or a continuous area of green pixels exceeds a threshold area, indicating a sky or sea or forest scene in the image. The spatial recognition algorithm can then be invoked to match the outlines of objects in the image to a database of tree and plant and water images, for example, and identify at block 74 the type of scene being imaged.

Or, the processor may determine that it should invoke an object recognition algorithm by virtue of detecting pixel patterns with enclosed borders of rectilinear shape, or of other non-human shapes such as purely circular shapes, elongated shapes indicating trains or other vehicles, etc. Having determined on this basis that an object such as a non-human object exists in the image, an object recognition algorithm may be employed to compare features of the objects as reflected in pixel patterns within the object image to a database of known objects to identify, at block 74, the object being imaged.

Yet again, the processor may determine that it should invoke a brand recognition algorithm by virtue of detecting pixel patterns that form letters, for example. Having determined on this basis that a brand name may appear in the image, a brand recognition algorithm may be employed to compare the brand name as reflected in pixel patterns to a database of known brand names to identify, at block 74, the brand being imaged.

Still further, the processor may determine that it should invoke a geo-specific (geography) recognition algorithm by virtue of detecting pixel patterns of enclosed boundaries that define objects of unusual size, e.g., objects larger than five meters in any particular dimension, as may be determined from both the pixel pattern and any existing focal length metadata that might accompany the image as appended by the imaging device from imager settings. Having determined on this basis that a geographically unique object such as Mt. Rushmore, the Eiffel Tower, etc. may appear in the image, a geography recognition algorithm may be employed to compare the geographic object as reflected in pixel patterns to a database of known geographic objects to identify, at block 74, the geographic area being imaged.

Time specific events may also be recognized using timestamps that may accompany the image from the imaging device, or using any of the algorithms above to recognize combinations of objects and then access a database of object combinations that are correlated to the times at which the objects appears together. As but one example, a face recognition algorithm may recognize the faces of two known celebrities in a single image, and then access a database of news feeds to determine when and at what events the two celebrities appeared together.

Proceeding to block 76, one or more metadata fields associated with the image are automatically populated using information from the recognition that occurs at block 74 to describe the image and if desired curate the image into one or more image categories in a searchable database of images. FIG. 3 illustrates examples of image metadata for three images numbered 1-3. Based on image recognition image #1 is appended with metadata (as in an electronic file of the image) indicating it contains people. Image #1 is also indicated by its metadata to being in the January 2011 timeframe, either as derived from exchangeable image file format (Exif) camera data generated along with the image and/or by the example time recognition algorithm described above. The species of person imaged has been recognized as being “Fred” at block 74 and a “species” field of the metadata so indicates. Images 2 and 3 likewise are classified into “places” and “things” categories, respectively, along with image time periods and particular place and thing species, in the example shown, “Paris” and “car”.

Returning to block 78 in FIG. 2, prior searches and previously stored data may be accessed and at block 80 compared with the metadata that was populated at block 76. Responsive to this comparison, at block 82 the metadata that had been populated at block 76 may be modified. Note that the prior searches may be accessed from a database of searches from Internet users at large as obtained from one or more public search engines, or the prior searches may be accessed from a database of searches entered only from the user's client device, or the prior searches may be accessed from a database of searches entered only by the particular user as identified form login information and correlated to searches. Yet again, the prior searches may be accessed from a database of searches entered only into a particular computer ecosystem such as a computer ecosystem provided by a vendor such as Sony Corp. The search database may be limited to only prior searches for images if desired.

As an example, suppose the prior searches indicate that the user previously searched for “Chevrolet” at least a threshold number of times. From this, it may be inferred, using for instance a database of synonyms such as a Thesaurus, that the user likes to image his vehicle and that the vehicle is a Chevrolet. In the context of the metadata in FIG. 3 for image #3, the species field may accordingly be changed from “car” to “Chevrolet”. More generally, the modification at block 82 of an original term metadata initially populated at block 76 may replace or add to the original term of metadata one or more synonyms of the metadata that appear with at least a threshold frequency in the prior searches and/or data accessed at block 78. Note further that the threshold frequency may be adaptive, i.e., it may be established by the frequency with which the original term appears in the prior searches or data accessed at block 78. For example, if a term of the original metadata populated at block 76 appears “N” times in the prior searches or data accessed at block 78, for a synonym to replace or be added to the original metadata at block 82, that synonym may have to appear a threshold number of times in the prior searches or data accessed at block 78 by N×A, where A is a scaling factor typically greater than zero, and that can be less than one or may be greater than one.

While the particular COMPUTER ECOSYSTEM WITH AUTOMATICALLY CURATED CONTENT is herein shown and described in detail, it is to be understood that the subject matter which is encompassed by the present invention is limited only by the claims.

What is claimed is:

1. A device comprising:
at least one computer readable storage medium bearing instructions executable by a processor;
at least one processor configured for accessing the computer readable storage medium to execute the instructions to configure the processor for:
recognizing at least one feature in an electronic image;
based on recognizing the at least one feature, automatically associating the image with an original metadata indicating the at least one feature;
comparing the original metadata with information in a data structure of prior terms; and
based on the comparing the original metadata with information in the data structure of prior terms, replacing the original metadata with modified metadata, or adding to the original metadata.

2. The device of claim 1, wherein the prior terms include prior search terms.

3. The device of claim 2, wherein the prior search terms are obtained from search terms entered by the public at large.

4. The device of claim 2, wherein the prior search terms are obtained solely from search terms entered into the device.

5. The device of claim 1, wherein the processor when executing the instructions is configured for replacing the original metadata with one or more synonyms of the original metadata that appear in the data structure of prior terms.

6. The device of claim 1, wherein the processor when executing the instructions is configured for adding to the original metadata one or more added metadata associated with the original metadata that appear in the data structure of prior terms.

7. The device of claim 1, wherein the processor when executing the instructions is configured for replacing the original metadata with modified metadata, or adding modified metadata to the original metadata, only if the modified metadata appears in the data structure of prior terms to satisfy a threshold.

8. The device of claim 7, wherein the threshold is adaptive.

9. The device of claim 7, wherein the threshold is established at least in part by a number of times the original metadata appears in the data structure of prior terms.

10. Method comprising:
analyzing a digital image;
based on analyzing the digital image, automatically associating metadata describing the image with the image; and
modifying the metadata based at least in part on information in a database.

11. The method of claim 10, wherein analyzing the image includes:
recognizing at least one feature in the image;
based on recognizing the at least one feature, automatically associating the image with an original metadata indicating the at least one feature.

12. The method of claim 11, comprising:
comparing the original metadata with information in a data structure of prior terms; and
based on the comparing the original metadata with information in the data structure of prior terms, replacing the original metadata with modified metadata, or adding to the original metadata.

13. The method of claim 10, comprising adding to the metadata one or more synonyms of the metadata that appear in the database.

14. The method of claim 13, comprising adding information to the metadata only if the information appears in the database to satisfy a threshold.

15. System comprising:
at least one computer readable storage medium bearing instructions executable by a processor which is configured for accessing the computer readable storage medium to execute the instructions to configure the processor for:
programmatically analyzing digital images;
based at least in part on programmatically analyzing the images, automatically populating metadata associated with the images with contextually relevant tags and markers for later referencing the images for curated entertainment; and
cross-referencing prior searches and/or existing databases and/or data sets to modify at least one of the tags to provide more relevant context and update the metadata.

16. The system of claim 15, wherein the processor when executing the instructions is further configured for:
recognizing at least one feature in an electronic image;
based on recognizing the at least one feature, automatically associating the image with an original metadata indicating the at least one feature;
comparing the original metadata with information in a data structure of prior terms; and
based on the comparing the original metadata with information in the data structure of prior terms, replacing the original metadata with modified metadata, or adding to the original metadata.

17. The system of claim 16, wherein the prior terms include prior search terms.

18. The system of claim 16, wherein the processor when executing the instructions is configured for replacing the original metadata with one or more synonyms of the original metadata that appear in the data structure of prior terms.

19. The system of claim 16, wherein the processor when executing the instructions is configured for adding to the original metadata one or more added metadata associated with the original metadata that appear in the data structure of prior terms.

20. The system of claim 16, wherein the processor when executing the instructions is configured for replacing the original metadata with modified metadata, or adding modified metadata to the original metadata, only if the modified metadata appears in the data structure of prior terms to satisfy a threshold.
